(19) United States
(12) Patent Application Publication
(10) Pub. No.: US 2014/0240751 A1
(43) Pub. Date: Aug. 28, 2014

(54) PRINTING APPARATUS, METHOD FOR CONTROLLING THE SAME, AND STORAGE MEDIUM

(71) Applicant: CANON KABUSHIKI KAISHA, Tokyo (JP)

(72) Inventor: Hiroki Takeishi, Machida-shi (JP)

(73) Assignee: CANON KABUSHIKI KAISHA, Tokyo (JP)

(21) Appl. No.: 14/186,648

(22) Filed: Feb. 21, 2014

(30) Foreign Application Priority Data
Feb. 22, 2013 (JP) 2013-033424

(51) Int. Cl. G06F 3/12

(52) U.S. Cl. CPC G06F 3/121; G06F 3/1234
USPC 358/1.14

(57) ABSTRACT

When transmitting print data to a printing apparatus by using a specific communication method, such as Wi-Fi Direct, and causing the printing apparatus to print the print data, if the print data is print data of a specific type, the printing apparatus performs error termination without performing printing.

### BACKGROUND OF THE INVENTION

1. Field of the Invention

The present invention relates to a printing apparatus, a method for controlling the printing apparatus, and a storage medium.

2. Description of the Related Art

A Wi-Fi Direct® standard is established by Wi-Fi Alliance. Wi-Fi Direct prescribes a protocol for determining whether an information processing apparatus, such as a printing apparatus and a personal computer (PC), operates as an access point or a client. Performing this protocol enables automatically determining an information processing apparatus which will serve as an access point, and an information processing apparatus which will serve as a client. Using Wi-Fi Direct eliminates the need of separately preparing an access point, and enables information processing apparatuses to directly perform wireless communication with each other.

FIG. 1 simply illustrates a processing sequence of Wi-Fi Direct. A printing apparatus and a portable terminal are examples of information processing apparatuses supporting Wi-Fi Direct.

In step S101, each of the printing apparatus and the portable terminal performs device search to identify a remote device to communicate with. In step S102, when each of the printing apparatus and the portable terminal identifies a remote device to communicate with through device search, they determine which will serve as an access point (GroupOwner) and which will serve as Client. The processing in step S102 is referred to as role determination. Referring to FIG. 1, suppose that the printing apparatus serves as GroupOwner and the portable terminal serves as Client as a result of the role determination in step S102.

In step S103, based on WPS (Wi-Fi Protected Setup) established by Wi-Fi Alliance, the printing apparatus (GroupOwner) provides the portable terminal (Client) with parameters for performing connection to share the parameters therebetween. In step S104, the printing apparatus and the portable terminal perform secure connection by using the parameters.

In step S105, upon completion of secure connection, the printing apparatus and the portable terminal perform addressing for performing IP communication therebetween. In this case, the printing apparatus (GroupOwner) functions as a Dynamic Host Configuration Protocol (DHCP) server, and gives an Internet Protocol (IP) address to the portable terminal (Client).

With the above-described processing, wireless communication is established between the printing apparatus and the portable terminal. Using this wireless communication enables the printing apparatus and the portable terminal to directly communicate with each other without separately preparing an access point. Japanese Patent Application Laid-Open No. 2012-199884 discusses a technique for transmitting and receiving sound data or photograph data by using Wi-Fi Direct.

Using Wi-Fi Direct enables a user to easily transmit print data from the portable terminal to the printing apparatus, and print the relevant data. However, providing such an easy printing method will increase the number of times of printing, which means that, for example, frequently performing color printing may possibly consume much toner. Such wasteful consumption applies not only to color printing. For example, frequently performing one-sided printing may possibly consume sheets in a wasted way.

To prevent this problem, it is assumed that a system administrator inhibits the specification of color printing or one-sided printing from a portable terminal. However, in Wi-Fi Direct, since various types of portable terminals are used, the system administrator cannot grasp which portable terminal will transmit print data to the printing apparatus. Therefore, it is very difficult to inhibit the specification of color printing or one-sided printing on all portable terminals.

### SUMMARY OF THE INVENTION

According to the present invention, for example, when transmitting print data to a printing apparatus by using a specific communication method, such as Wi-Fi Direct, and causing the printing apparatus to print the print data, it is possible to inhibit the printing apparatus from printing print data of a specific type.

The present invention is directed to a printing apparatus.

A printing apparatus according to the present invention includes a reception unit configured to receive print data transmitted from an external apparatus, a printing unit configured to perform printing based on the print data received by the reception unit, and a control unit configured to, when the print data received by the reception unit is print data of a specific type and the reception unit receives the print data by using a specific communication method, control the printing unit not to perform printing based on the print data of the specific type, and to, when the print data received by the reception unit is print data of the specific type and the reception unit receives the print data by using a communication method different from the specific communication method, control the printing unit to perform printing based on the print data of the specific type.

Further features and aspects of the present invention will become apparent from the following detailed description of exemplary embodiments with reference to the attached drawings.

### BRIEF DESCRIPTION OF THE DRAWINGS

FIG. 1 illustrates a processing sequence of Wi-Fi Direct.

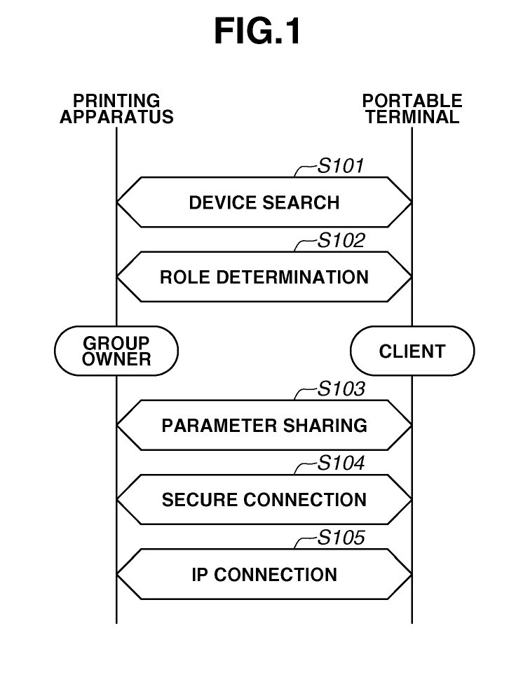

FIG. 2 illustrates a configuration of a printing system.

FIG. 3 illustrates a hardware configuration of a printing apparatus.

FIG. 4 illustrates a setting screen.

FIG. 5 is a flowchart illustrating processing performed by a printing apparatus according to a first exemplary embodiment.

FIG. 6 illustrates a setting screen.

FIG. 7 is a flowchart illustrating processing performed by a printing apparatus according to a second exemplary embodiment.

FIG. 8 illustrates a setting screen.

FIG. 9 is a flowchart illustrating processing performed by a printing apparatus according to a third exemplary embodiment.

### DESCRIPTION OF THE EMBODIMENTS

Various exemplary embodiments, features, and aspects of the invention will be described in detail below with reference to the drawings. The following exemplary embodiments do not limit the present invention within the ambit of the appended claims. Not all of the combinations of the features described in the exemplary embodiments are indispensable to the solutions for the present invention.

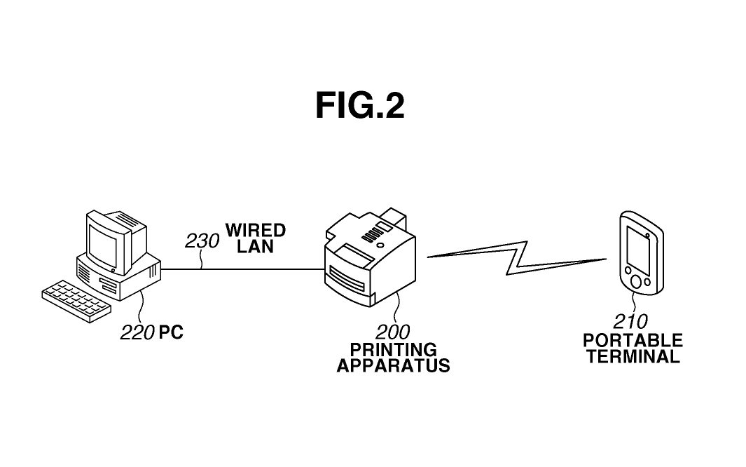

FIG. 2 illustrates a configuration of an entire printing system according to the present exemplary embodiment.

A printing apparatus 200 and a portable terminal 210 are capable of communicating with each other through wireless communication, such as Wi-Fi Direct. Although, in the present exemplary embodiment, the printing apparatus 200 will be described as a multifunction peripheral, the printing apparatus 200 may be a printer not having a scanner.

The portable terminal 210 is capable of transmitting print data to the printing apparatus 200 through wireless communication, such as Wi-Fi Direct. The portable terminal 210 is, for example, a smart phone, a mobile phone, a tablet computer, or a digital camera.

The printing apparatus 200 is also capable of communicating with a PC 220 via a wired local area network (LAN) 230. The PC 220 is capable of transmitting print data to the printing apparatus 200 via the wired LAN 230.

A processing sequence in which the portable terminal 210 transmits print data to the printing apparatus 200 via wireless communication established by using Wi-Fi Direct, and the printing apparatus 200 prints the print data is hereinafter referred to as Wi-Fi Direct printing.

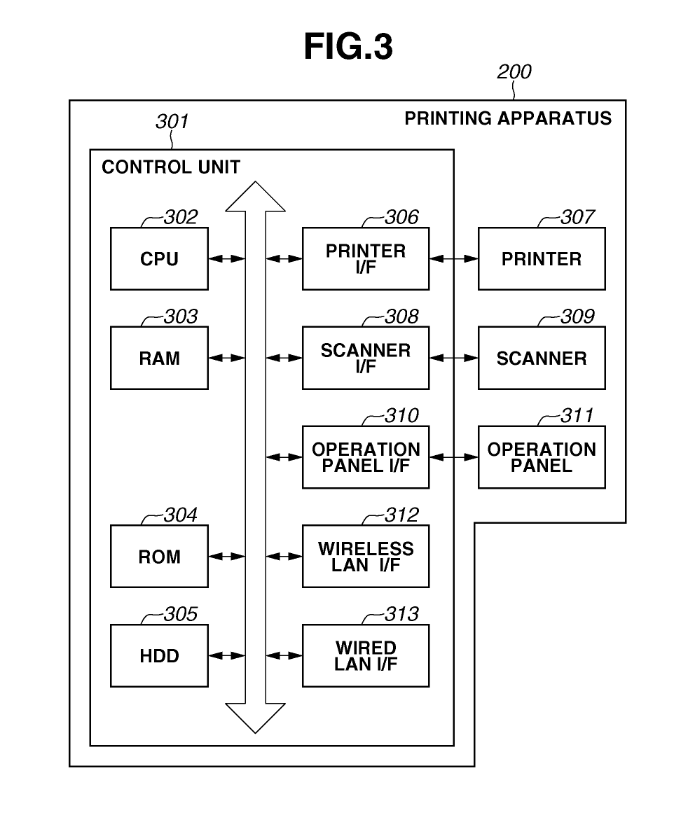

FIG. 3 illustrates a hardware configuration of the printing apparatus 200.

A control unit 301 including a central processing unit (CPU) 302 controls an operation of the entire printing apparatus 200. The CPU 302 reads a control program stored in a read-only memory (ROM) 304, and performs various control, such as communication control. A random access memory (RAM) 303 is used as a main memory for the CPU 302 and a temporary area such as a work area. A hard disk drive (HDD) 305 stores data, various programs, and various information tables.

A printer interface (I/F) 306 connects a printer 307 (printer engine) and the control unit 301. The printer 307 executes print processing on a sheet fed from a sheet cassette (not illustrated), based on print data input via the printing apparatus I/F 306.

A scanner I/F 308 connects a scanner 309 and the control unit 301. The scanner 309 reads a document placed thereon, and generates image data. The image data generated by the scanner 309 is printed by the printer 307, stored in the HDD 305, or transmitted to an external apparatus via a wireless LAN I/F 312 or a wired LAN I/F 313.

An operation panel I/F 310 connects an operation panel 311 and the control unit 301. The operation panel 311 is provided with a liquid crystal display unit having a touch panel function, a keyboard, and various function keys. The user can confirm a screen displayed on the operation panel 311, or input various instructions to the printing apparatus 200 by using the touch panel.

The wireless LAN I/F 312 performs wireless communication with an external apparatus, such as a portable terminal and a PC. With this wireless communication, the printing apparatus 200 receives print data from an external apparatus, and the printer 307 performs print processing based on the received print data. The printing apparatus 200 is also capable of transmitting the image data generated by the scanner 309 to an external apparatus via the wireless LAN I/F 312.

A LAN cable (not illustrated) connected to the wired LAN I/F 313 enables performing communication with an external apparatus (not illustrated).

Although, in the printing apparatus 200, the CPU 302 executes processing illustrated in each flowchart (described below) by using a memory (RAM 303), the printing apparatus 200 may have other execution modes. For example, it is also possible that a plurality of CPUs and a plurality of memories cooperate with each other to execute processing illustrated in each flowchart (described below).

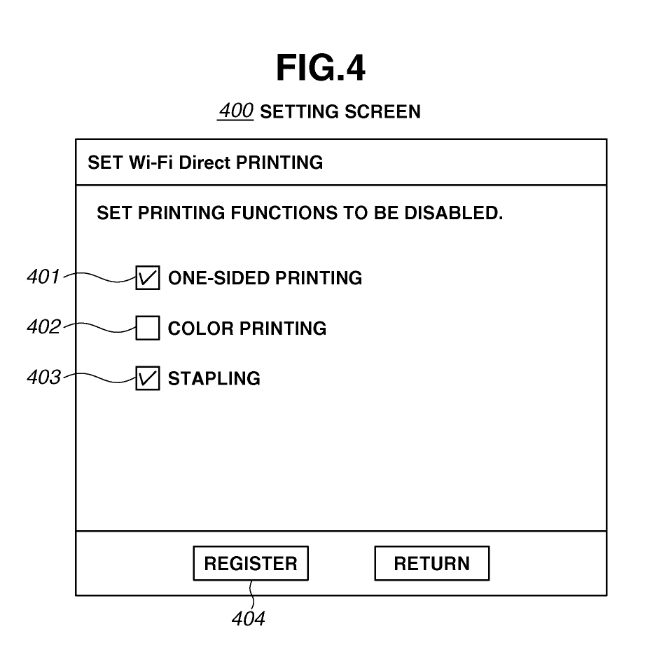

A setting screen 400 illustrated in FIG. 4 is displayed on the operation panel 311 of the printing apparatus 200. In the setting screen 400, the user can specify a printing function (print setting) to be disabled in Wi-Fi Direct printing.

In the setting screen 400, the user can select a desired printing function from one-sided printing, color printing, and stapling (items 401 to 403) as a printing function to be disabled in Wi-Fi Direct printing. For example, disabling one-sided printing enables preventing wasteful consumption of sheets in Wi-Fi Direct printing, disabling color printing enables preventing wasteful consumption of toner, and disabling stapling enables preventing wasteful consumption of strips of staple. When the user presses a REGISTER icon 404, the printing functions selected in the setting screen 400 by the user are stored in memory, such as the HDD 305, as printing functions to be disabled in Wi-Fi Direct printing.

Although, in the present exemplary embodiment, any user can make setting in the setting screen 400, it is also possible that only a specific user (for example, a user having administrator's authority) can make setting in the setting screen 400 by introducing a user authentication function to the printing apparatus 200. The items 401 to 403 illustrated in FIG. 4 are to be considered as examples of printing functions which can be set to be disabled. Other printing functions may be set to be disabled.

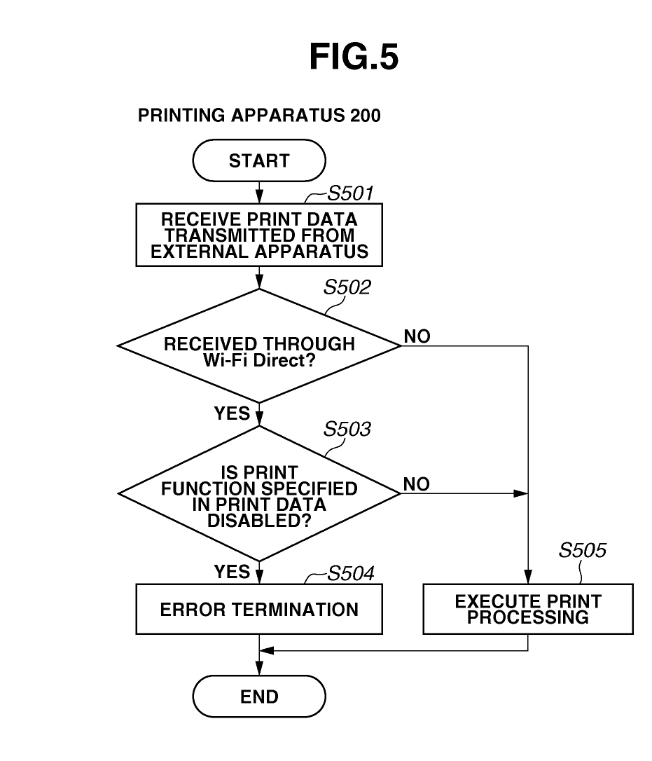

The following describes processing performed by the printing apparatus 200 upon reception of print data transmitted from an external apparatus, with reference to the flowchart illustrated in FIG. 5. Each step in the flowchart illustrated in FIG. 5 is implemented when the CPU 302 loads a program stored in memory, such as the ROM 304, into the RAM 303, and then executes it.

In step S501, the wireless LAN I/F 312 or the wired LAN I/F 313 receives print data transmitted from the external apparatus. When the wireless LAN I/F 312 receives print data, it receives the print data transmitted from the portable terminal 210 through wireless communication established by using Wi-Fi Direct. On the other hand, when the wired LAN I/F 313 receives print data, it receives the print data transmitted from the PC 220 via the wired LAN 230. A printing function is specified in the print data received in step S501.

In step S502, the CPU 302 determines whether the print data was received through Wi-Fi Direct in step S501. When the wireless LAN I/F 312 receives the print data through wireless communication established by using Wi-Fi Direct, the CPU 302 determines that the print data was received through Wi-Fi Direct (YES in step S502), and the processing proceeds to step S503. Otherwise, when the wired LAN I/F 313 receives the print data via the wired LAN 230, the CPU 302 determines that the print data was received not through Wi-Fi Direct (NO in step S502), and the processing proceeds to step S505.

Step S503 will be described below. In step S503, referring to the information stored in memory, such as the HDD 305, the CPU 302 determines whether any one of the printing functions specified in the print data is disabled. For example, when one of the printing functions specified in the print data is color printing, and color printing is set to be disabled in the setting screen 400, the CPU 302 determines that one of the printing functions specified in the print data is disabled (YES in step S503), and the processing proceeds to step S504. Otherwise, when one of the printing functions specified in the print data is color printing, and color printing is not set to be disabled in the setting screen 400, for example, the CPU 302 determines that the printing function specified in the print data is not disabled (NO in step S503), and the processing proceeds to step S505. In the present exemplary embodiment, the CPU 302 handles the print data in which one of printing functions set to be disabled in the setting screen 400 is specified, as print data of a specific type.

Step S504 will be described below. Processing in step S504 is executed when print data is received through Wi-Fi Direct, and one of the printing functions specified in the print data is set to be disabled in Wi-Fi Direct printing. In step S504, the CPU 302 executes error termination without executing printing based on the received print data. In step S504, the CPU 302 may display the error termination on the operation panel 311, or notify the portable terminal 210 of the error termination. The portable terminal 210 which received the relevant notification may display the error termination.

Step S505 will be described below. In step S505, the CPU 302 controls the printer 307 to execute printing based on the received print data. At this time, the printing function specified in the print data is also executed. Processing in step S505 is executed when the wired LAN I/F 313 receives the print data via the wired LAN 230. In this case, since the print data is received not through Wi-Fi Direct, printing is performed based on the print data regardless of the settings in the setting screen 400. Also, when the wireless LAN I/F 312 receives print data through Wi-Fi Direct, printing is performed based on the print data in step S505 if the printing function specified in the print data is not the printing function set to be disabled in the setting screen 400.

As described above, in the present exemplary embodiment, the user registers a printing function to be disabled in Wi-Fi Direct printing to the printing apparatus 200 through the setting screen 400. This enables limiting printing functions executable at the time of Wi-Fi Direct printing, preventing wasteful consumption of toner or sheets. When print data is received through a communication method different from Wi-Fi Direct, for example, via the wired LAN 230, the printing function specified in the print data can be executed regardless of the settings in the setting screen 400.

Although, in the first exemplary embodiment, printing functions, such as one-sided printing and color printing, have specifically been described as functions to be disabled in Wi-Fi Direct printing, functions to be disabled in Wi-Fi Direct printing are not limited thereto. A second exemplary embodiment will be described below as a modification of the first exemplary embodiment. The configuration of the printing apparatus 200 is similar to that in the first exemplary embodiment, and redundant descriptions thereof will be omitted.

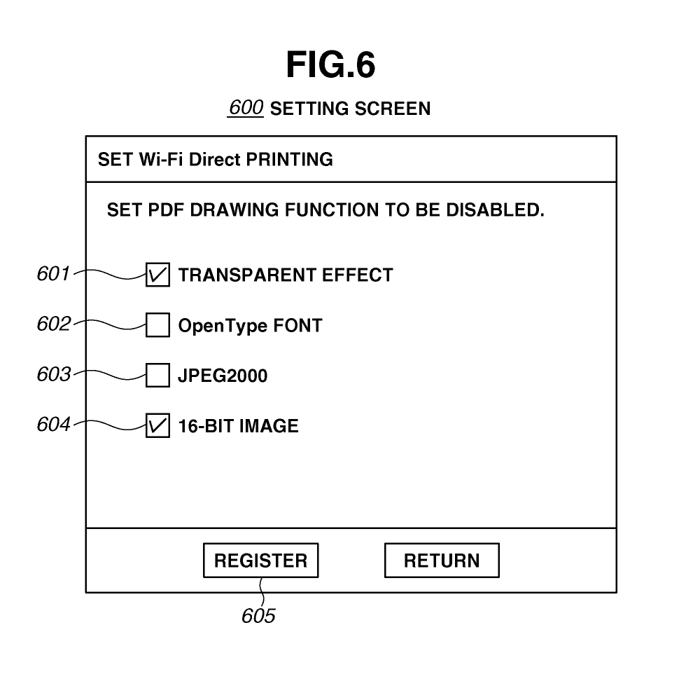

A setting screen 600 illustrated in FIG. 6 is displayed on the operation panel 311 of the printing apparatus 200. In the setting screen 600, the user can specify a Portable Document Format (PDF) drawing function to be disabled in Wi-Fi Direct printing.

The setting screen 600 displays transparent effect, OpenType font, JPEG 2000, and 16-bit image as drawing functions specified in a PDF file (items 601 to 604). The transparent effect and OpenType font are drawing functions added in PDF 1.4, and JPEG 2000 and 16-bit image are drawing functions added in PDF 1.5. When the CPU 302 executes these drawing functions, the processing load on the CPU 302 may increase, and the efficiency of communication with an external apparatus performed by the printing apparatus 200 may decrease. Accordingly, in the present exemplary embodiment, these drawing functions are disabled in Wi-Fi Direct printing.

In the setting screen 600, the user selects (specifies), by using the items 601 to 604, a PDF drawing function to be disabled in Wi-Fi Direct printing. Then, when the user presses an icon 605, the PDF drawing functions selected in the setting screen 600 by the user are stored in memory, such as the HDD 305, as PDF drawing functions to be disabled in Wi-Fi Direct printing.

Although, in the present exemplary embodiment, any user can make setting in the setting screen 600, only a specific user (for example, a user having administrator's authority) can make setting in the setting screen 600 by introducing a user authentication function to the printing apparatus 200. The items 601 to 604 illustrated in FIG. 6 are to be considered as examples of PDF drawing functions which can be set to be disabled. Other drawing functions may be set to be disabled.

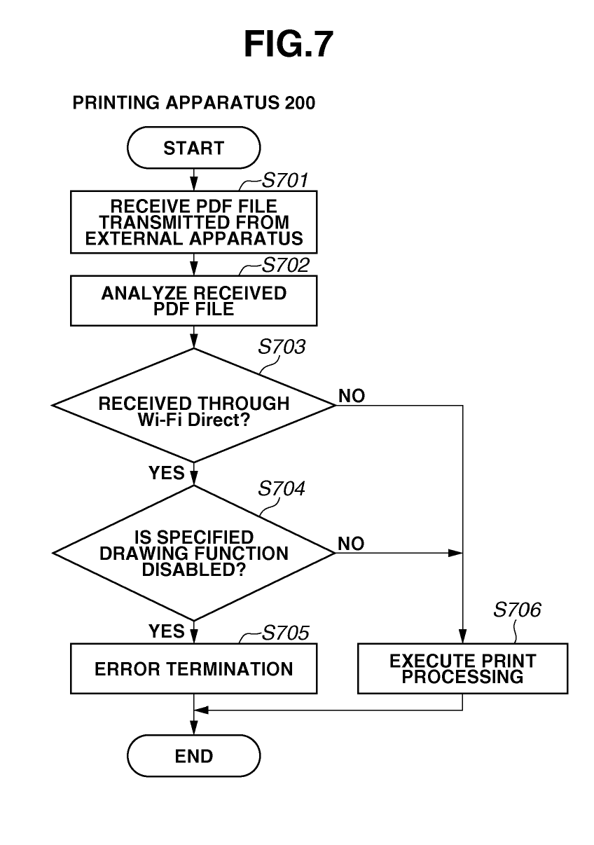

The following describes processing performed by the printing apparatus 200 upon reception of print data transmitted from an external apparatus, with reference to the flowchart illustrated in FIG. 7. Each step in the flowchart illustrated in FIG. 7 is implemented when the CPU 302 loads a program stored in memory, such as the ROM 304, into the RAM 303, and then executes it.

In step S701, the wireless LAN I/F 312 or the wired LAN I/F 313 receives a PDF file transmitted from the external apparatus. When the wireless LAN I/F 312 receives a PDF file, it receives the PDF file transmitted from the portable terminal 210 through wireless communication established by using Wi-Fi Direct. On the other hand, when the wired LAN I/F 313 receives a PDF file, it receives the PDF file transmitted from the PC 220 via the wired LAN 230. The PDF file received in step S701 includes a drawing command for specifying various drawing functions. In the present exemplary embodiment, the PDF file received from the external apparatus is an example of print data printed on the printing apparatus 200.

In step S702, the CPU 302 analyzes the received PDF file. With the analysis in step S702, the CPU 302 can identify a drawing function specified in the PDF file.

In step S703, the CPU 302 determines whether the PDF file was received through Wi-Fi Direct in step S701. When the wireless LAN I/F 312 receives the PDF file through wireless communication established by using Wi-Fi Direct, the CPU 302 determines that the PDF files was received through Wi-Fi Direct (YES in step S703), and the processing proceeds to step S704. Otherwise, when the wired LAN I/F 313 receives the PDF file via the wired LAN 230, the CPU 302 determines that the PDF file was received not through Wi-Fi Direct (NO in step S703), and the processing proceeds to step S706.

Step S704 will be described below. In step S704, referring to the information stored in memory such as the HDD 305, the CPU 302 determines whether any one of the drawing functions specified in the PDF file is disabled. For example, when one of the drawing functions specified in the PDF file is the transparent effect and the transparent effect is set to be disabled in the setting screen 600, the CPU 302 determines that one of the drawing functions specified in the PDF file is disabled (YES in step S704), and the processing proceeds to step S705. Otherwise, when one of the drawing functions specified in the PDF file is the transparent effect and the transparent effect is not set to be disabled in the setting screen 600, the CPU 302 determines that the drawing function specified in the PDF file is not disabled (NO in step S704), and the processing proceeds to step S706. In the present exemplary embodiment, the CPU 302 handles the PDF file in which one of the drawing functions set to be disabled in the setting screen 600 is specified, as print data of a specific type.

Step S705 will be described below. Processing in step S705 is executed when the PDF file is received through Wi-Fi Direct, and one of the drawing functions specified in the PDF file is set to be disabled in Wi-Fi Direct printing. In step S705, the CPU 302 executes error termination without executing printing based on the received PDF file. In step S705, the CPU 302 may display the error termination on the operation panel 311, or notify the portable terminal 210 of the error termination. The portable terminal 210 which received the relevant notification may display the error termination.

Step S706 will be described below. In step S706, the CPU 302 controls the printer 307 to execute printing based on the received PDF file. At this time, the drawing functions specified in the PDF file are also performed. Processing in step S706 is executed when the wired LAN I/F 313 receives a PDF file via the wired LAN 230. In this case, since the PDF file is received not through Wi-Fi Direct, printing is performed based on the PDF file regardless of the settings in the setting screen 600. Also, when the wireless LAN I/F 312 receives a PDF file through Wi-Fi Direct, printing is performed based on the PDF file in step S706 if the drawing function specified in the PDF file is not the drawing function set to be disabled in the setting screen 600.

As described above, in the present exemplary embodiment, the user registers a PDF drawing function to be disabled in Wi-Fi Direct printing to the printing apparatus 200 through the setting screen 600. This enables limiting PDF drawing functions executable at the time of Wi-Fi Direct printing, and reducing the load on the CPU 302. When a PDF file is received through a communication method different from Wi-Fi Direct, for example, via the wired LAN 230, the drawing function specified in the PDF file can be executed regardless of the settings in the setting screen 600.

A third exemplary embodiment will be described below as a modification of the second exemplary embodiment. The configuration of the printing apparatus 200 is similar to that in the first exemplary embodiment, and redundant descriptions thereof will be omitted.

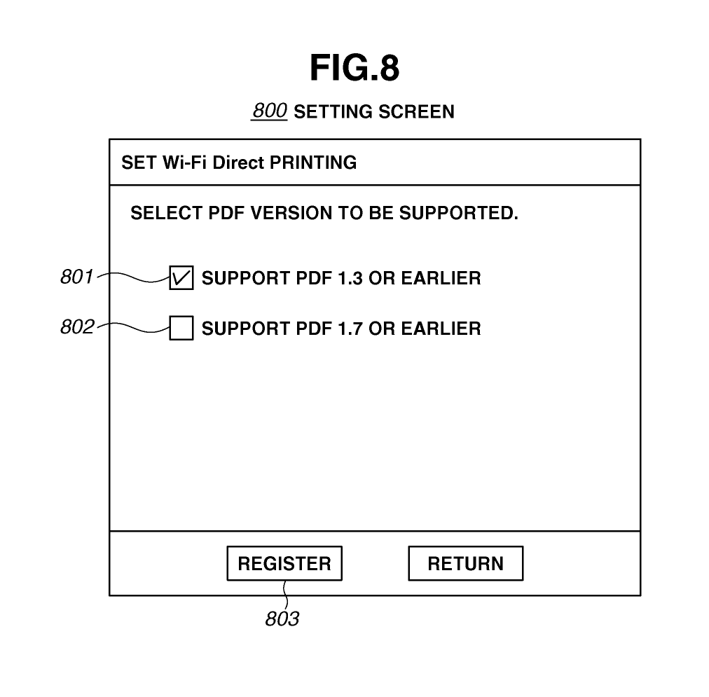

The setting screen 800 illustrated in FIG. 8 is displayed on the operation panel 311 of the printing apparatus 200. In the setting screen 800, the user can specify the PDF version to be supported in Wi-Fi Direct printing.

When the user selects an item 801, PDF 1.3 or earlier will be supported in Wi-Fi Direct printing. Otherwise, when the user selects an item 802, PDF 1.7 or earlier will be supported in Wi-Fi Direct printing. When the user select the item 801, the drawing functions added in PDF 1.4 or later (transparent effect, OpenType font, JPEG 2000, and 16-bit image) will be disabled in Wi-Fi Direct printing.

In the setting screen 800, the user selects (specifies), by using the items 801 and 802, a PDF version to be supported by the printing apparatus 200 in Wi-Fi Direct printing. When the user presses an icon 803, the setting selected in the setting screen 800 by the user is stored in memory, such as the HDD 305, as a PDF version to be supported by the printing apparatus 200 in Wi-Fi Direct printing.

Although, in the present exemplary embodiment, any user can make setting in the setting screen 800, only a specific user (for example, a user having administrator's authority) can make setting in the setting screen 800 by introducing a user authentication function to the printing apparatus 200. The items 801 and 802 illustrated in FIG. 8 are to be considered as examples of PDF versions which can be specified not to be supported. Other versions may be specified not to be supported.

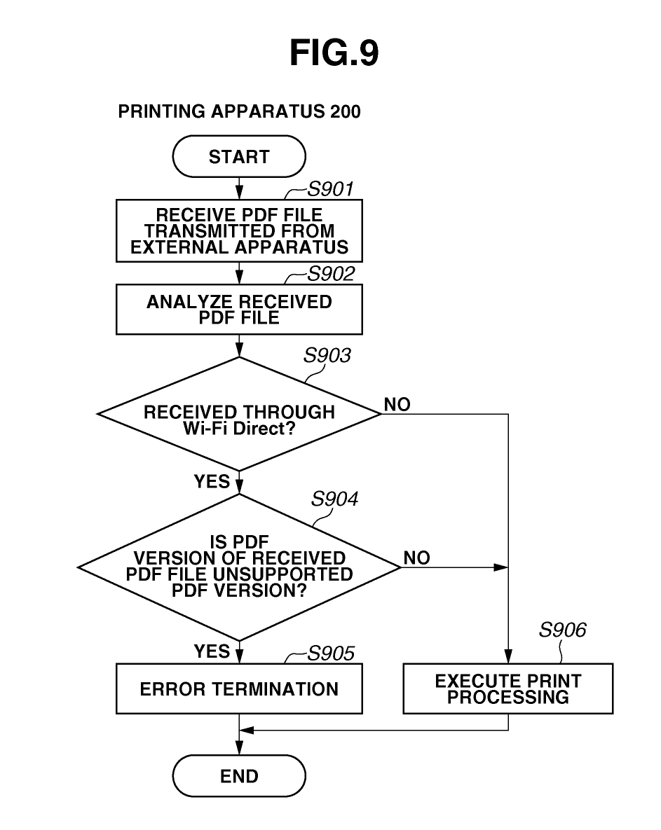

The following describes processing performed by the printing apparatus 200 upon reception of print data transmitted from an external apparatus, with reference to the flowchart illustrated in FIG. 9. Each step in the flowchart illustrated in FIG. 9 is implemented when the CPU 302 loads a program stored in memory, such as the ROM 304, into the RAM 303, and then executes it.

In step S901, the wireless LAN I/F 312 or the wired LAN I/F 313 receives a PDF file transmitted from the external apparatus. When the wireless LAN I/F 312 receives a PDF file, it receives the PDF file transmitted from the portable terminal 210 through wireless communication established by using Wi-Fi Direct. On the other hand, when the wired LAN I/F 313 receives a PDF file, it receives the PDF file transmitted from the PC 220 via the wired LAN 230. The PDF file received in step S901 includes a drawing command for specifying various drawing functions. In the present exemplary embodiment, the PDF file received from the external apparatus is an example of print data printed on the printing apparatus 200.

In step S902, the CPU 302 analyzes the received PDF file. With the analysis in step S902, the CPU 302 can identify the PDF version of the PDF file. In the present exemplary embodiment, the CPU 302 can identify the PDF version of the PDF file based on header information at the top of the PDF file. The CPU 302 may identify the PDF version of the PDF file by using other methods.

In step S903, the CPU 302 determines whether the PDF file was received through Wi-Fi Direct in step S901. When the wireless LAN I/F 312 receives the PDF file through wireless communication established by using Wi-Fi Direct, the CPU 302 determines that the PDF file was received through Wi-Fi Direct (YES in step S903), and the processing proceeds to step S904. Otherwise, when the wired LAN I/F 313 receives the PDF file via the wired LAN 230, the CPU 302 determines that the PDF file was received not through Wi-Fi Direct (NO in step S903), and the processing proceeds to step S906.

Step S904 will be described below. In step S904, referring to information stored in memory, such as the HDD 305, the CPU 302 determines whether the PDF version of the received PDF file is a PDF version unsupported in Wi-Fi Direct printing. For example, when the received PDF file is PDF 1.7 and “SUPPORT PDF 1.3 OR EARLIER” is set in the setting screen 800, the CPU 302 determines that the PDF version of the received PDF file is an unsupported PDF version (YES in step S904), and the processing proceeds to step S905. Otherwise, for example, when the received PDF file is PDF 1.7 and “SUPPORT PDF 1.7 OR EARLIER” is set in the setting screen 800, the CPU 302 determines that the PDF version of the received PDF file is not an unsupported PDF version (NO in step S904), and the processing proceeds to step S906. In the present exemplary embodiment, the CPU 302 handles the PDF file of the PDF version set not to be supported in the setting screen 800 as print data of a specific type.

Step S906 will be described below. In step S906, the CPU 302 controls the printer 307 to execute printing based on the received PDF file. At this time, the drawing function specified in the PDF file is also performed. Processing in step S906 is executed when the wired LAN I/F 313 receives a PDF file via the wired LAN 230. In this case, since the PDF file is received not through Wi-Fi Direct, printing is performed based on the PDF file regardless of the settings in the setting screen 800. Also, when the wireless LAN I/F 312 receives a PDF file through Wi-Fi Direct, printing is performed based on the PDF file in step S906 if the PDF version of the received PDF file is set as a version to be supported by the printing apparatus 200.

As described above, in the present exemplary embodiment, the user registers a PDF version unsupported in Wi-Fi Direct printing to the printing apparatus 200 in the setting screen 800. This enables limiting PDF drawing functions executable at the time of Wi-Fi Direct printing, and reducing the load on the CPU 302. When a PDF file is received through a communication method different from Wi-Fi Direct, for example, via the wired LAN 230, the drawing function specified in the PDF file can be executed regardless of the settings in the setting screen 800.

Unlike the setting screen 600, the setting screen 800 allows the user to register whether each PDF version is to be supported or not. Therefore, even a user who does not concretely grasp PDF drawing functions can limit functions to be executed in Wi-Fi Direct printing, by using the setting screen 800.

Although, in the above-described exemplary embodiments, the printing apparatus 200 and the portable terminal 210 execute Wi-Fi Direct as wireless communication, wireless communication is not limited to Wi-Fi Direct. The present invention is applicable to wireless communication enabling direct communication between a plurality of communication apparatuses, such as Wi-Fi Direct.

Although, in the above-described exemplary embodiments, wireless communication using Wi-Fi Direct is used as an example of a specific communication method, other wireless communications may be used as a specific communication method.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, for example, when transmitting print data to a printing apparatus by using a specific communication method, such as Wi-Fi Direct, and causing the printing apparatus to print the print data, it is possible to inhibit the printing apparatus from printing print data of a specific type.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2013-033424 filed Feb. 22, 2013, which is hereby incorporated by reference herein in its entirety.

What is claimed is:

1. A printing apparatus comprising:
a reception unit configured to receive print data transmitted from an external apparatus;
a printing unit configured to perform printing based on the print data received by the reception unit; and
a control unit configured to, when the print data received by the reception unit is print data of a specific type and the reception unit receives the print data by using a specific communication method, control the printing unit not to perform printing based on the print data of the specific type, and to, when the print data received by the reception unit is print data of the specific type and the reception unit receives the print data by using a communication method different from the specific communication method, control the printing unit to perform printing based on the print data of the specific type.

2. The printing apparatus according to claim 1, wherein, when the print data received by the reception unit is print data of the specific type and the reception unit receives the print data by using the specific communication method, the control unit controls the printing apparatus to perform error termination.

3. The printing apparatus according to claim 2, further comprising:
a notification unit configured to, when the print data received by the reception unit is print data of the specific type and the reception unit receives the print data by using the specific communication method, notify the external apparatus of the error termination.

4. The printing apparatus according to claim 1, wherein the print data of the specific type is print data in which a specific printing function is specified.

5. The printing apparatus according to claim 1, wherein the print data of the specific type is print data in which a specific PDF drawing function is specified.

6. The printing apparatus according to claim 1, wherein the print data of the specific type is PDF data of a specific version.

7. The printing apparatus according to claim 1, wherein the specific communication method is wireless communication based on Wi-Fi Direct.

8. A method for controlling a printing apparatus, the method comprising:
receiving print data transmitted from an external apparatus;
performing printing based on the received print data; and
controlling, when the received print data is print data of a specific type and the print data is received by using a specific communication method, not to perform printing based on the print data of the specific type, and, controlling, when the received print data is print data of the specific type and the print data is received by using a communication method different from the specific communication method, to perform printing based on the print data of the specific type.

9. A storage medium storing a program for causing a computer to execute the method for controlling a printing apparatus according to claim 8.
